(19) United States
(12) Patent Application Publication
(10) Pub. No.: US 2015/0379040 A1
(43) Pub. Date: Dec. 31, 2015

(54) GENERATING AUTOMATED TOURS OF GEOGRAPHIC-LOCATION RELATED FEATURES

(71) Applicant: Google Inc., Mountain View, CA (US)

(72) Inventors: Alan Sheridan, San Jose, CA (US); Daniel Joseph Filip, San Jose, CA (US)

(21) Appl. No.: 14/317,865

(22) Filed: Jun. 27, 2014

(51) Int. Cl. G06F 17/30

(52) U.S. Cl. CPC G06F 17/30241

(57) ABSTRACT

Tours may be automatically generated that move between geographically-relevant imagery associated with a set of features at different geographic locations. By way of example, in response to searching for businesses or landmarks falling within a particular category and geographic area, a user may be taken on a visual tour of each business or landmark that was found as a result of the search.

### BACKGROUND

Various systems permit users to playback a sequence of images as a tour. For instance, some systems may provide a video-like flying experience that allows a user to use a browser that moves an individual through still images of the earth or images rendered on 3-dimensional geography. Users may be permitted to manually order and display different types of imagery to create a tour, such as selecting from still images, panoramic images and other tours. Images may also be automatically selected or suggested for inclusion in a tour by identifying points of interest for which there are a relatively high number of overlapping images captured by a single or multiple users. Images may be further automatically selected based on quality criteria.

### BRIEF SUMMARY

Aspects of the disclosure provide a method of generating an automated tour. The method includes identifying, by one or more computing devices, a set of features where each feature of the set of features is associated with a different geographic location. For each given feature of the set of features, a sequence of imagery is identified that represents the given feature. A sequence of the features of the set of features is determined, where the order of the sequence of features is based at least in part on one or more of the associated location of each feature of the set of features and a relative ranking of the features in the set of features. An automated tour of the set of features to display is generated in accordance with the sequence of features, the location of each given feature of the set of features on a map, and the sequence of images that capture the given feature.

Another aspect of the disclosure provides a system that includes one or more processors and a memory. The memory stores a set of features, where each feature of the set of features is associated with a different geographic location, and imagery representing each feature. The instructions include: identifying, for each given feature of the set of features, a sequence of imagery that represents the given feature; determining a sequence of the features of the set of features, where the order of the sequence of features is based at least in part on one or more of the associated location of each feature of the set of features and a relative ranking of the features in the set of features; and generating an automated tour of the set of features to display, in accordance with the sequence of features, the location of each given feature of the set of features on a map and the sequence of images that capture the given feature.

Yet another aspect of the disclosure provides a non-transitory computer-readable storage medium on which computer readable instructions of a program are stored. The instructions, when executed by one or more processors, cause the one or more processors to perform a method. The method includes identifying, by one or more computing devices, a set of features where each feature of the set of features is associated with a different geographic location. The method also includes identifying, for each given feature of the set of features, a sequence of imagery that represents the given feature. The method further includes determining, a sequence of the features of the set of features, where the order of the sequence of features is based at least in part on one or more of the associated location of each feature of the set of features and a relative ranking of the features in the set of features. The method also includes generating an automated tour of the set of features to display, in accordance with the sequence of features, the location of each given feature of the set of features on a map and the sequence of images that capture the given feature.

### BRIEF DESCRIPTION OF THE DRAWINGS

FIG. 1 is a functional diagram of a system in accordance with an aspect of the system and method.

FIG. 2 is a schematic representation of features at geographic locations.

FIG. 3 is a schematic representation of imagery of a feature.

FIG. 4 is a schematic representation of selected imagery of a feature.

FIG. 5 is a schematic representation of a tour of imagery of a feature.

FIG. 6 is a schematic representation of a tour of features at geographic locations.

FIG. 7 is a schematic representation of a tour of imagery of features.

FIG. 8 is a screen shot displayed to a user.

FIGS. 9A and 9B are a set of screen shots displayed to a user.

FIG. 10 is an example flow diagram in accordance with aspects of the disclosure.

### DETAILED DESCRIPTION

Overview

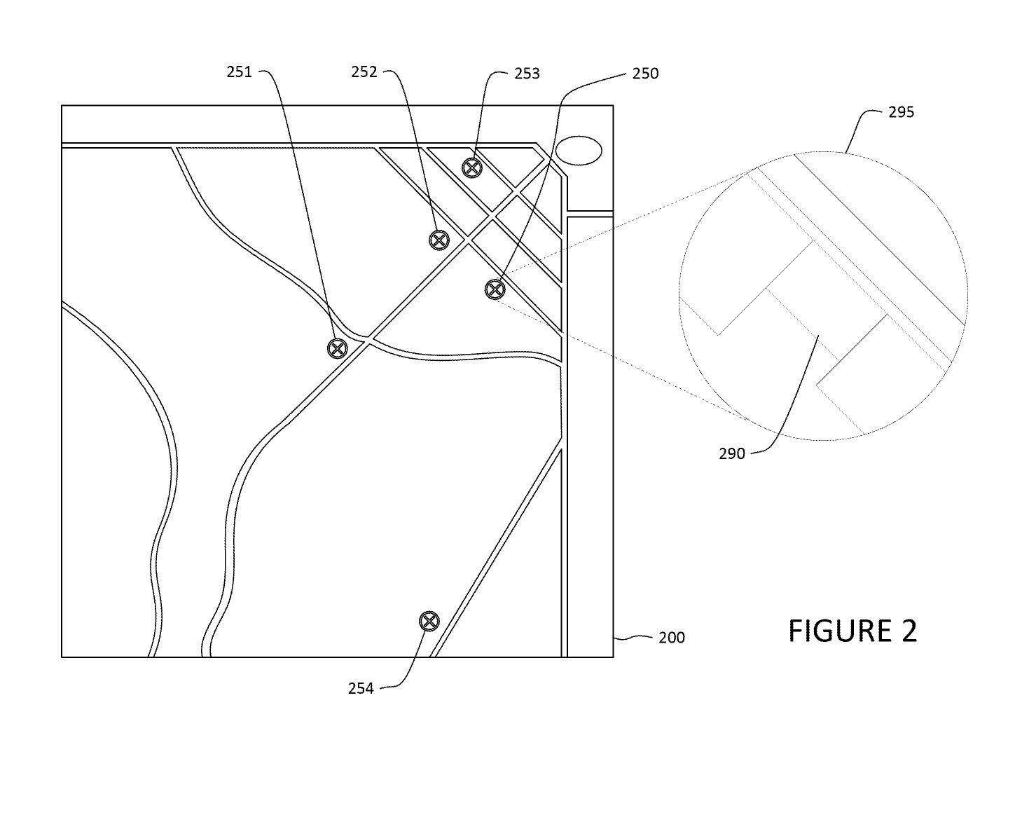

The technology relates to automatically generating tours that move between geographically-relevant images associated with a set of features at different geographic locations. By way of example, in response to searching for businesses or landmarks falling within a particular category and geographic area, a user may be taken on a visual tour of each business or landmark that was found as a result of the search. For instance and as shown in FIG. 2, the set of features may include a set of restaurants that are located at different streets within a defined geographic area.

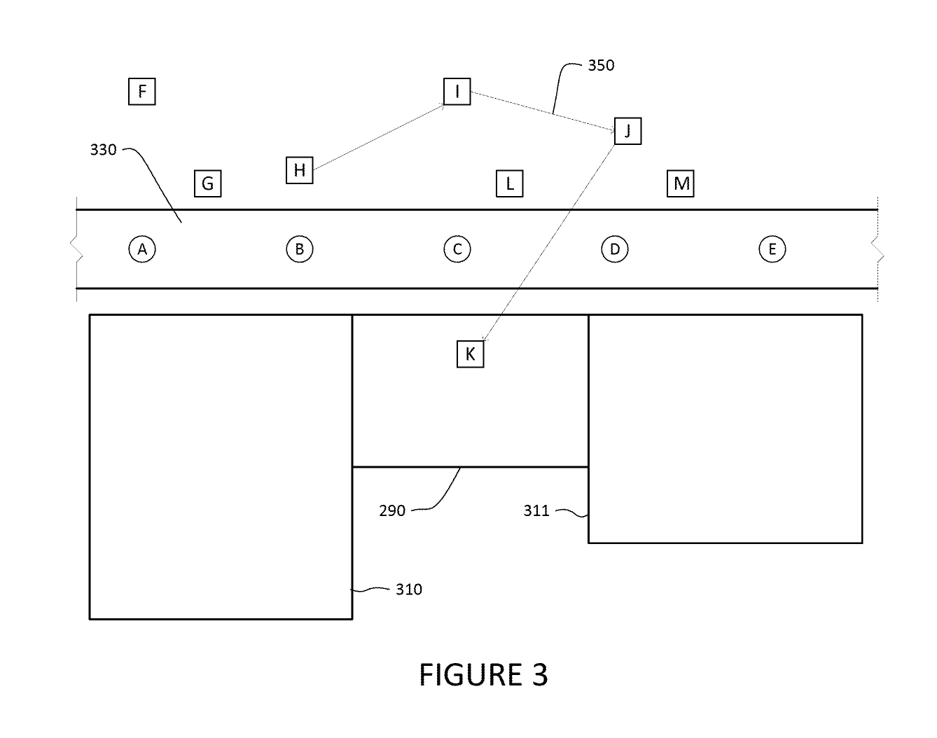

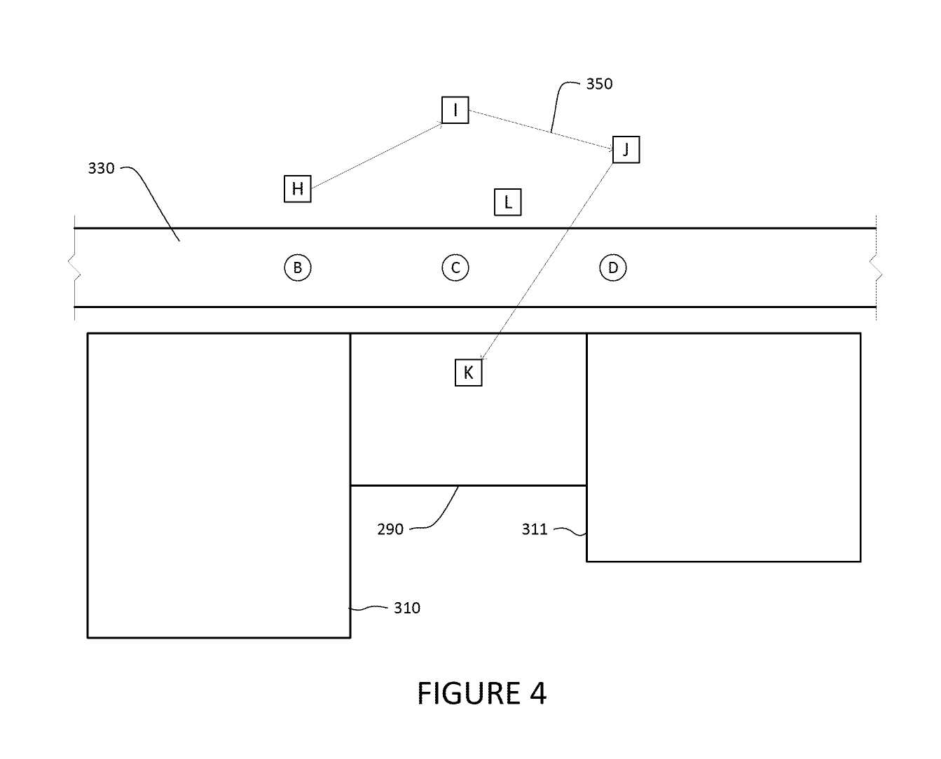

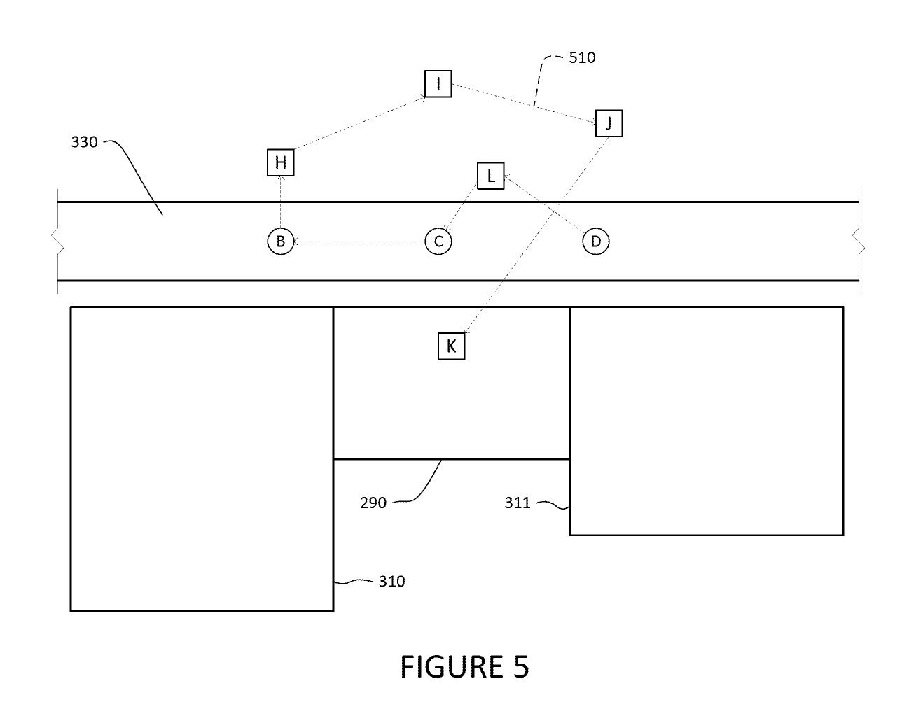

For each feature, the computing device may identify imagery associated with the feature. For instance and as shown in FIG. 3, the imagery may include panoramic images taken from different locations on the street in front of the building that houses one of the identified restaurants. The imagery may also include individual user photos or video of the building, as well as an existing tour of the inside and outside of the restaurant. As shown in FIG. 4, the computing device may select the images that best fit certain criteria and, as shown in FIG. 5, may then determine a sequence in which those images will be displayed to the user. The imagery may be selected so that, when displayed in sequence, the angle of view turns towards the feature. For instance, sequencing of the imagery may convey the impression of moving around the feature while keeping the feature in view.

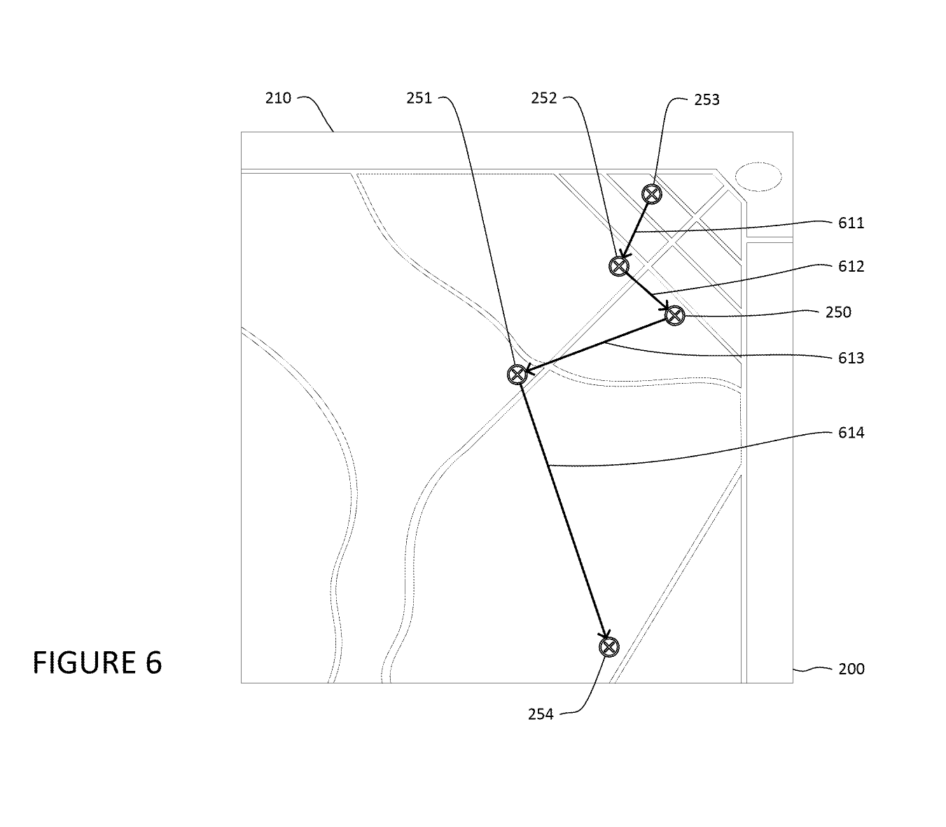

The computing device may also order the list of features. By way of example and as shown in FIG. 6, the computing device may calculate the shortest path that includes all of the features. Other orders are also possible, such as the highest rated location to lowest (if applicable), closest to a particular location (e.g., current location, a city center, an airport, etc.), and the like.

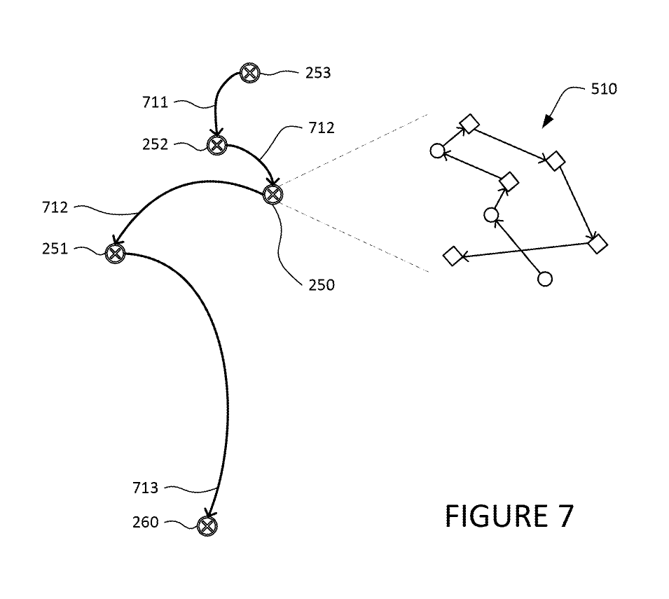

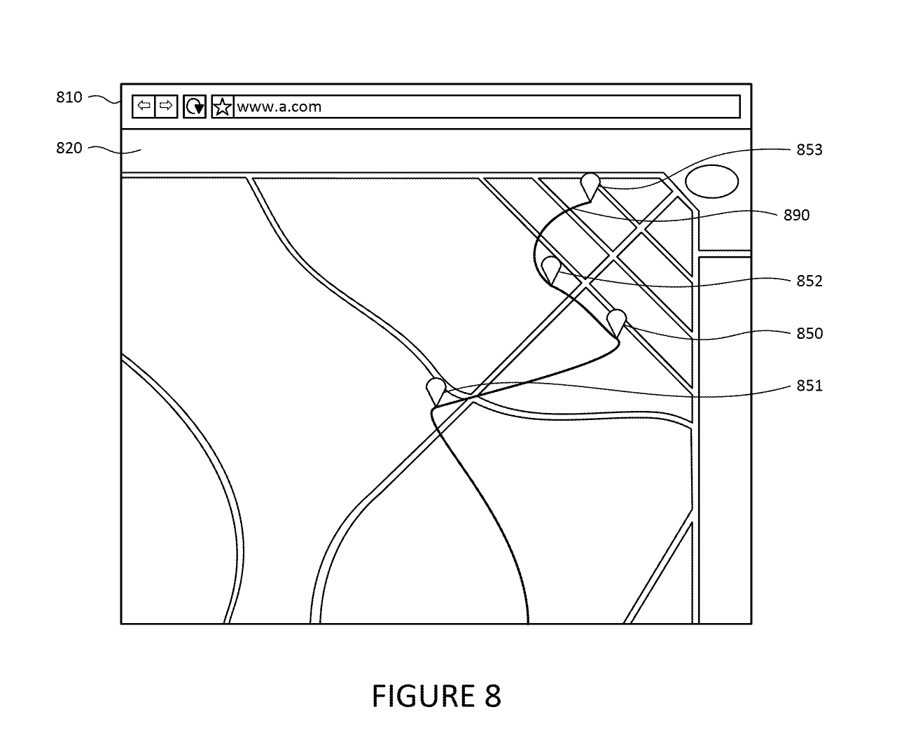

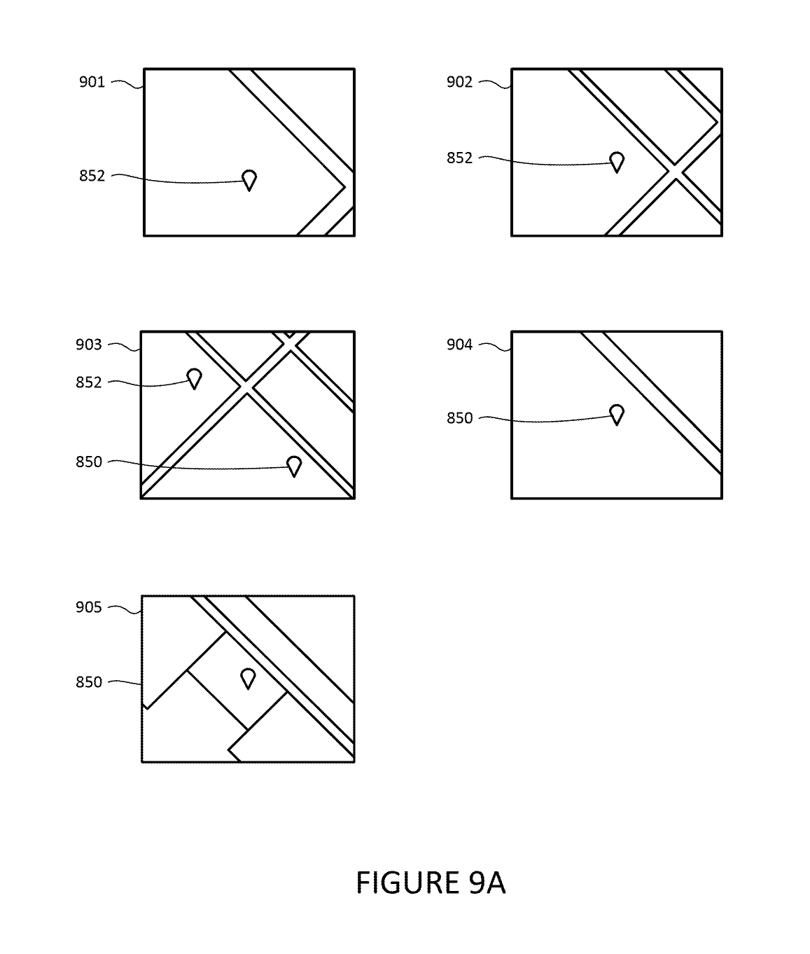

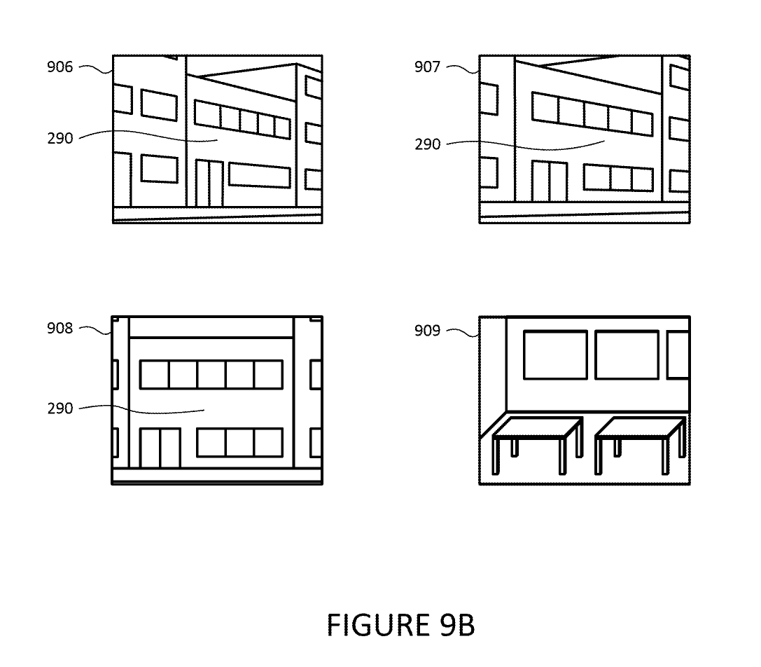

As shown in FIG. 7, the ordered list of features and the feature-specific sequence of images form, in the aggregate, a tour of the features. For instance, as shown in FIG. 8, the computing device may initially display a map of the features and a path indicating the order in which the features will be visited. As shown in the screen shots of FIG. 9, when transitioning from one feature to another feature, the display may: show the location of the first feature on a map, zoom out of the map, pan to the second feature, zoom into the map at the location of the second feature, and then display a tour of the second feature as a sequence of images capturing the feature from different viewpoints. The remaining features may be displayed, in order, in the same manner.

Example Systems

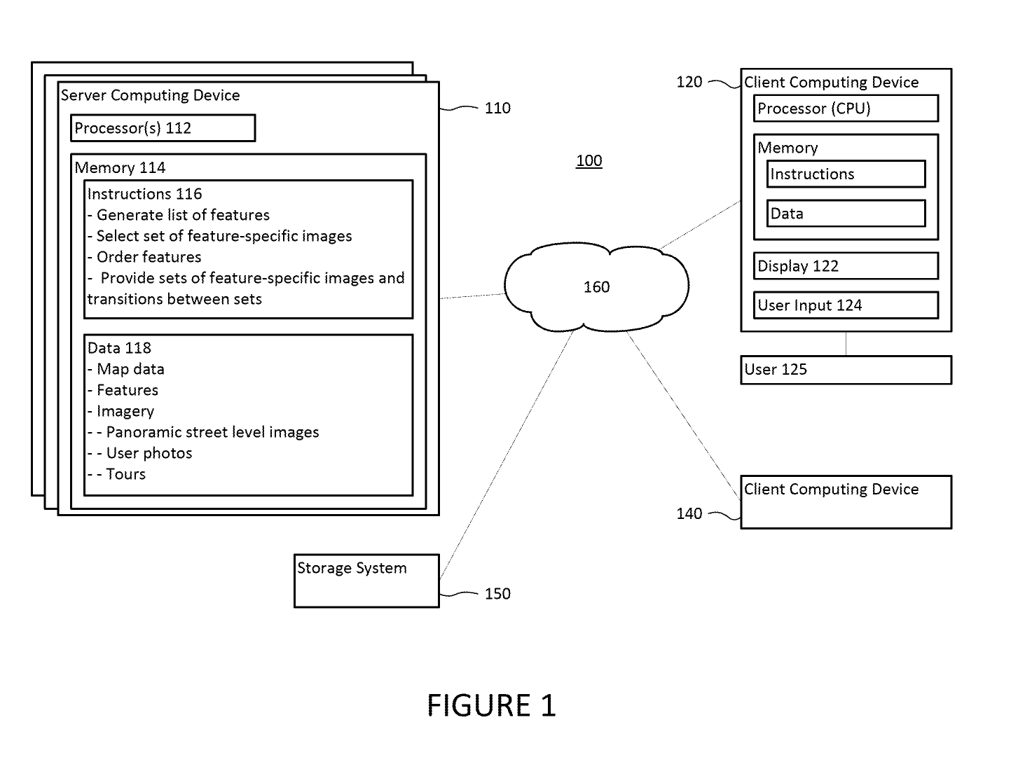

FIG. 1 illustrates one possible system 100 in which the aspects disclosed herein may be implemented. In this example, system 100 may include computing devices 110, 120 and 140. Computing devices 110 may contain one or more processors 112, memory 114 and other components typically present in general purpose computing devices. Although FIG. 1 functionally represents each of the processor 112 and memory 114 as a single block within device 110, which is also represented as a single block, the system may include and the methods described herein may involve multiple processors, memories and devices that may or may not be stored within the same physical housing. For instance, various methods described below as involving a single component (e.g., processor 112) may involve a plurality of components (e.g., multiple processors in a load-balanced server farm). Similarly, various methods described below as involving different components (e.g., device 110 and device 120) may involve a single component (e.g., rather than device 120 performing a determination described below, device 120 may send the relevant data to device 110 for processing and receive the results of the determination for further processing or display).

Memory 114 of computing device 110 may store information accessible by processor 112, including instructions 116 that may be executed by the processor 112. Memory 114 may also include data 118 that may be retrieved, manipulated or stored by processor 112. Memory 114 and the other memories described herein may be any type of storage capable of storing information accessible by the relevant processor, such as a hard-disk drive, a solid state drive, a memory card, RAM, DVD, write-capable memory or read-only memory. In addition, the memory may include a distributed storage system where data, such as data 150, is stored on a plurality of different storage devices which may be physically located at the same or different geographic locations.

The instructions 16 may be any set of instructions to be executed by processor 112 or other computing device. In that regard, the terms “instructions,” “application,” “steps” and “programs” may be used interchangeably herein. The instructions may be stored in object code format for immediate processing by a processor, or in another computing device language including scripts or collections of independent source code modules, that are interpreted on demand or compiled in advance. Functions, methods and routines of the instructions are explained in more detail below. Processor 112 may be any conventional processor, such as a commercially available CPU. Alternatively, the processor may be a dedicated component such as an ASIC or other hardware-based processor.

Data 118 may be retrieved, stored or modified by computing device 110 in accordance with the instructions 116. For instance, although the subject matter described herein is not limited by any particular data structure, the data may be stored in computer registers, in a relational database as a table having many different fields and records, or XML documents. The data may also be formatted in any computing device-readable format such as, but not limited to, binary values, ASCII or Unicode. Moreover, the data may comprise any information sufficient to identify the relevant information, such as numbers, descriptive text, proprietary codes, pointers, references to data stored in other memories such as at other network locations, or information that is used by a function to calculate the relevant data.

The computing device 110 may be at one node of a network 160 and capable of directly and indirectly communicating with other nodes of network 160. Although only a few computing devices are depicted in FIG. 1, a typical system may include a large number of connected computing devices, with each different computing device being at a different node of the network 160. The network 160 and intervening nodes described herein may be interconnected using various protocols and systems, such that the network may be part of the Internet, World Wide Web, specific intranets, wide area networks, or local networks. The network may utilize standard communications protocols, such as Ethernet, Wi-Fi and HTTP, protocols that are proprietary to one or more companies, and various combinations of the foregoing. As an example, computing device 110 may be a web server that is capable of communicating with computing device 120 via the network 160. Computing device 120 may be a client computing device, and server 110 may display information by using network 160 to transmit and present information to a user 125 of device 120 via display 122. Although certain advantages are obtained when information is transmitted or received as noted above, other aspects of the subject matter described herein are not limited to any particular manner of transmission of information.

Computing device 120 may be configured similarly to the server 110, with a processor, memory and instructions as described above. Computing device 170 may be a personal computing device intended for use by a user and have all of the components normally used in connection with a personal computing device such as a central processing unit (CPU), memory storing data and instructions, a display such as display 122 (e.g., a monitor having a screen, a touch-screen, a projector, a television, or other device that is operable to display information), and user input device 124 (e.g., a mouse, keyboard, touch-screen, microphone, etc.). Computing device 120 may also comprise a mobile computing device capable of wirelessly exchanging data with a server over a network such as the Internet. By way of example only, device 120 may be a mobile phone or a device such as a wireless-enabled PDA, a tablet PC, a wearable computing device or a netbook that is capable of obtaining information via the Internet. The device may be configured to operate with an operating system such as Google's Android operating system, Microsoft Windows or Apple iOS. In that regard, some of the instructions executed during the operations described herein may be provided by the operating system whereas other instructions may be provided by an application installed on the device. Computing devices in accordance with the systems and methods described herein may include other devices capable of processing instructions and transmitting data to and from humans and/or other computers including network computers lacking local storage capability and set top boxes for televisions.

Server 110 may store map-related information, at least a portion of which may be transmitted to a client device. The map information is not limited to any particular format. For instance, the map data may include bitmap images of geographic locations such as photographs captured by a satellite or aerial vehicles. The map data may also include information that may be rendered as images in advance or on demand, such as storing street locations and pedestrian trails as vectors, and street and trail names as text.

Server 110 may also store features associated with geographic locations. For example, features may include a landmark, a store, a lake, a point of interest, or any other visual object or collection of objects at a given location. Locations may also be expressed in various ways including, by way of example only, latitude/longitude, a street address, x-y coordinates relative to edges of a map (such as a pixel position relative to the edge of a street map), and other reference systems capable of identifying geographic locations (e.g., lot and block numbers on survey maps). Moreover, a location may define a range of the foregoing. For example, a satellite image may be associated with a set of vertices defining the boundaries of an area, such as storing the latitude/longitude of each location captured at the corner of the image. The system and method may further translate locations from one reference system to another. For example, the server 110 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939°)). In that regard, locations received or processed in one reference system may also be received or processed in other references systems.

Server 110 may further store imagery of, or otherwise associated with, a feature or a geographic location proximate to a feature. By way of example, if the feature is a restaurant, imagery associated with the restaurant may include panoramic images taken from different locations on the street in front of the building that houses one of the identified restaurants. The imagery may also include individual user photos or video of the building, such as a photo taken by a user for the express purpose of making the photo available to anyone searching for information related to the restaurant. A user photo may also include a photo taken inside the restaurant where the subject of the photo was the user's friends and the restaurant provides a convenient backdrop. Other examples of imagery are described below.

Example Methods

Operations in accordance with a variety of aspects of the invention will now be described. It should be understood that the following operations do not have to be performed in the precise order described below. Rather, various steps can be handled in reverse order or simultaneously.

Server 110 may receive a request for a tour of features related to certain characteristics. For instance, in response to input from user 215, client device 120 may transmit to server 110 via network 160 a request for a tour of certain types of features within a given area. In response, processor(s) 112 of server 110 may query data 118 for all features that are located within the requested area and obtain a list of results in response. FIG. 2 illustrates the example of a set of features 250-54 at different street addresses that were retrieved based on a query from a user for restaurants within the area covered by the map 200. Reference 295 provides a closer view of a particular building 290 housing restaurant 250.

Imagery associated with each feature within the set of features may be identified. Continuing the foregoing example and as illustrated in FIG. 3, server 100 may identify panoramic street-level images A-E captured at different locations along the street but within a certain distance of the location of the feature, e.g., building 290 between buildings 310 and 311. The server may also identify user photos captured at locations proximate to the feature, such as photos F, G, L and M. Server 100 may also select only those images that are within a latitude/longitude area bounded by a polygon or other shape. Server 110 may further identify any pre-existing tours of the feature. By way of example, the owner of the restaurant may have uploaded photos H, I and J of the outside of the restaurant, as well as a video K of the interior. The owner may have stored tour 350 at the server by identifying the order in which the imagery should be displayed, e.g., such as displaying photo H, fading to and displaying photo I, fading to and displaying photo J, and then finally showing video K of the interior. In some aspects, users searching for information about the restaurant would be provided with a chance to view the tour 350.

Imagery of the feature may be ranked based on how well the imagery captures the feature. By way of example, in advance of the aforementioned request and for each feature stored in the system, the system may identify imagery that is known or likely to have captured the feature. Each image may be ranked based on various criteria, such as distance to the feature, camera angle (e.g., whether the camera was pointed directly at the feature at the time the image was captured), how well the image matches a known image of the feature, contrast, semantic information (e.g., the image may have been obtained from the restaurant's website), the identity of the user that uploaded the image, the type of capture device, etc. For instance, because the capture location of panoramic image C (FIG. 3) is on the street 330 directly in front of building 290, the portions of image C that capture building 290 may be ranked highly and ultimately selected for inclusion in an automatically-generated tour.

A given number of the highest-ranked imagery for a feature may be selected as the best fit for inclusion in a tour. FIG. 4 illustrates a selection of the highest-ranked imagery for the restaurant contained in building 290, namely street level images B, C and D, preexisting tour 350 and user photo L. In other aspects, a maximum number of imagery, regardless of type, may be selected and in still other aspects, a maximum number of each type of imagery (e.g., videos, still images) may be selected.

The selected imagery for the feature may be automatically sequenced to create a tour of the feature. The imagery may be selected so that, when displayed in sequence, the angle of view turns towards the feature. For instance, sequencing of the imagery may convey the impression of moving around the feature while keeping the feature in view. In that regard and as shown in FIG. 5, the server may order the images in new tour 510 by starting with an image that is to the side of the feature such as image D. The next images in the ordered listed may be image L, which is taken closer to the center of the feature than image D, and then image C, which is taken directly in front of the feature. Image C may be followed by image B on the other side of the feature. The server may also select only those portions of the panoramic images that are oriented towards the location of building 290. Finally, the system may append or otherwise include preexisting tour 350 in new tour 510.

The system may also order the list of features. By way of example and as shown in FIG. 6, the computing device may use a travelling salesman algorithm to calculate the shortest path 611-614 that includes all of the retrieved features 250-54. Other orders may also be used, such as the highest rated location to lowest (if applicable), closest to a particular location (e.g., current location, a city center, an airport, etc.), and the like.

As shown in FIG. 7, the ordered list of features and the feature-specific sequence of images form, in the aggregate, a tour of the features. Using the example shown in the figure, the tour begins with a tour specific to the first selected feature 253253 and, when the tour of feature 253 is complete, moves along path 711 to a tour of feature 252. After the tour of feature 252, the tour moves along path 712 until reaching feature 250, and proceeds to tour feature 250 in accordance with previously-described feature-specific tour 510. After feature 250 is toured, the tour moves along path 712 to tour feature 251, and then finally moves along path 713 to tour feature 260.

FIGS. 8-9 illustrate how the tour may appear on a display. The search results may be shown on browser 810 on display 122 as a set of markers 850-53 on a map 820. Each marker may indicate the location of a feature to be visited during the tour. A path 890 may be determined and displayed that connects the features in the order in which the features will be visited.

FIG. 9 is a series of screen shots that provide an example of transitioning from one feature to another feature. In screen shot 901, marker 852 is displayed on the map at the location of feature 252. In screen shot 902, the display zooms out, creating the impression of rising out of the map. In screen shot 903, the display pans from marker 852 to marker 850, where marker 850 indicates the location of feature 250. In screen shot 904, the display pans until marker 850 is at the center of the screen. In screen shot 905, the display zooms in towards the feature. Additional details may be retrieved and displayed as the view zooms in, such as retrieving a satellite image of the feature. The display then begins displaying the tour that is specific to feature 250. For instance, screen shot 906 may correspond with image D of FIG. 5, e.g., an image of building 290 taken from the side. In screen shot 906, the tour moves to image L, which is also taken to the side of building 290, but closer to the center. In screen shot 908, the tour moves to image C, taken directly in front of the building. The tour may then proceed to each of the next images in the feature-specific tour, e.g., imagery B, H, I, J and K. For example, upon reaching imagery K, the tour may show a video of the interior of the restaurant as shown in screen shot 909. For other features, the feature-specific tour may wrap all the way around the feature.

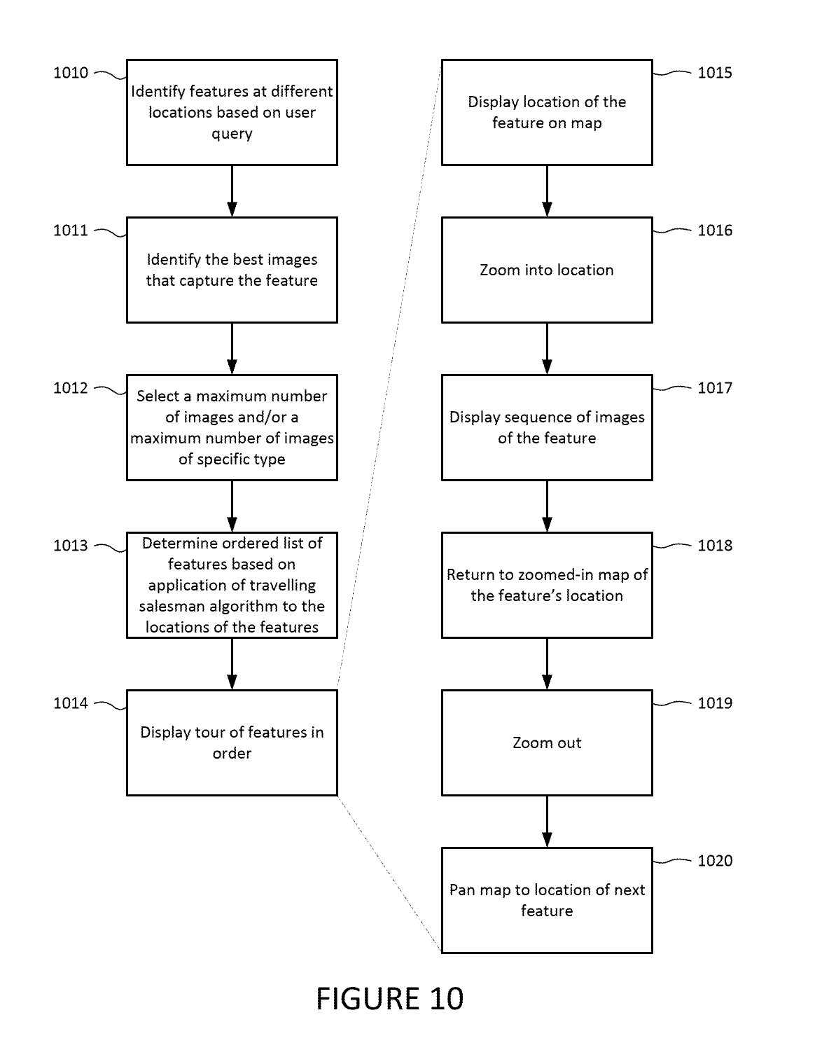

The flow diagram of FIG. 10 provides an example of some of the features described above that may be performed by one or more computing devices. Features may be identified at different locations at block 1010. The best images capturing the feature may be identified at block 1011. A maximum number of images and/or a maximum number of images of a specific type may be selected at block 1012. An ordered list of features may be determined based on the application of a travelling-salesman algorithm to the location of the features at block 1013. A tour of the features may be shown in accordance with the order determined by the algorithm, at block 1014. Elements of block 1014 are shown in more detail at blocks 1015-20. For instance, the location of the feature may be shown on the map at block 1015. The display may zoom into the location at block 1016. The images selected for the feature may be displayed in sequence at block 1017. The display may return to the zoomed-in view of the map at block 1018. The display may then zoom back out of the map and pan to the location of the next feature at blocks 1019 and 1020, whereupon the next feature is also shown in accordance with blocks 1015-20.

As noted above, the features may be selected based on various criteria. By way of further example, the features and imagery may be selected based on the locations visited by a user. For instance, in response to a user's request to tour their imagery of a city, the one or more computing devices may identify the specific locations of images uploaded by a user. The one or more computing devices may then determine the images that are likely to be of most interest to the user. For example, the one or more computing devices may identify any multiple images that were uploaded by the user and captured in close proximity to a single location. Such clustered images may be considered an indication that the user found something interesting at the location. The amount of images captured by other users proximate to the same location may be another signal that the location contains a feature interesting to the user. The one or more computing devices may query data 118 to determine if there are known features in the area. If so, a tour of feature may be created as described above. If not, a tour of the location may be created by selecting the best images captured proximate to the location based on criteria that is not specific to a particular feature.

Imagery may be further limited to imagery that captures a particular user. Continuing the foregoing example, the one or more computing devices may use facial and other recognition techniques to only select images that include a specific user, such as the user that uploaded the image or a person (e.g., a son or daughter) identified by another user.

As these and other variations and combinations of the features discussed above can be utilized without departing from the invention as defined by the claims, the foregoing description of the embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A computer-implemented method of generating an automated tour comprising:
identifying, by one or more computing devices, a set of a plurality of features where each feature of the set of features is a visual object associated with a geographic location that is different from the geographic locations associated with other features of the set;
identifying, by the one or more computing devices and for each given feature of the set of features, a sequence of imagery that captures the given feature, where the imagery of the sequence is identified at least in part on how well the imagery captures the given feature;
determining, by the one or more computing devices, a sequence of the features of the set of features, where the order of the sequence of features is based on the location of each feature of the set of features and a relative ranking of the features in the set of features; and
providing, by the one or more computing devices and for display, in the order of and for each feature in the determined sequence of features, a sequence of imagery that captures the feature, the location of the feature on a map and, excluding the last feature of the sequence of features, a pan of the map to the location of the next feature in the sequence of features.

2. (canceled)

3. The method of claim 1 wherein identifying the set of features comprises ranking features based on a query provided by a user and selecting features based on the rank, wherein the query is based at least in part on search criteria that is not specific to a geographic location.

4. The method of claim 3 wherein identifying the set of features is based at least in part on whether the geographic location associated with a given feature is within a geographic area selected by the user.

5. (canceled)

6. The method of claim 1 wherein identifying a sequence of imagery that capture a given feature comprises identifying a plurality of panoramic images taken at different geographic locations.

7. The method of claim 6 wherein identifying the sequence of imagery that capture a given feature further comprises identifying, for each panoramic image, the portion of the panoramic image that captures the given feature.

8. The method of claim 6 wherein identifying a sequence of imagery comprises identifying photos taken by a plurality of different users.

9. The method of claim 1 wherein determining the sequence of features comprises calculating a shortest path that includes the associated geographic locations of all of the features of the set of features.

10. (canceled)

11. A system for generating an automated tour comprising:
one or more processors; and
a memory storing a set of a plurality of features where each feature of the set of features is a visual object associated with a geographic location that is different from the geographic locations associated with other features in the set, and imagery representing each feature;
wherein the instructions comprise:
identifying, for each given feature of the set of features, a sequence of imagery that captures the given feature, where the imagery of the sequence is identified at least in part on how well the imagery captures the given feature;
determining a sequence of the features of the set of features, where the order of the sequence of features is based on the location of each feature of the set of features and a relative ranking of the features in the set of features; and
providing for display, in the order of and for each feature in the determined sequence of features, a sequence of imagery that captures the feature, the location of the feature on a map and, excluding the last feature of the sequence of features, a pan of the map to the location of the next feature in the sequence of features.

12. The system of claim 11 further comprising a display, and wherein the providing for display comprises providing the location of a feature on a map, the pan of the map and sequence of imagery to the display.

13. The system of claim 11 wherein identifying the plurality of features comprises ranking features based on a query provided by a user and selecting features based on the rank, wherein the query is based at least in part on search criteria that is not specific to a geographic location.

14. (canceled)

15. The system of claim 11 wherein identifying at least one sequence of imagery comprises identifying photos taken by a plurality of different users.

16. A non-transitory computer-readable storage medium on which computer readable instructions of a program are stored, the instructions, when executed by one or more processors, cause the one or more processors to perform a method, the method comprising:
identifying a set of a plurality of features where each feature of the set of features is a visual object associated with a geographic location that is different from the geographic locations associated with other features of the plurality;
identifying, for each given feature of the set of features, a sequence of imagery that captures the given feature, where the imagery of the sequence is identified at least in part on how well the imagery captures the given feature;
determining a sequence of the features of the set of features, where the order of the sequence of features is based on the location of each feature of the set of features and a relative ranking of the features in the set of features; and
providing for display, in the order of and for each feature in the determined sequence of features, a sequence of imagery that captures the feature, the location of the feature on a map and, excluding the last feature of the sequence of features, a pan of the map to the location of the next feature in the sequence of features.

17. (canceled)

18. The medium of claim 16, wherein identifying the set of features comprises ranking features based on a query provided by a user and selecting features based on the rank, wherein the query is based at least in part on search criteria that is not specific to a geographic location.

19. The medium of claim 16, wherein identifying the set of features is based at least in part on whether the geographic location associated with a given feature is within a geographic area selected by the user.

20. (canceled)

21. The method of claim 1, wherein providing the location of a feature on as map for display comprises indicating the location of the feature on the map with a marker.

22. The system of claim 11, wherein providing the location of a feature on a map for display comprises indicating the location of the feature on the map with a marker.

23. The medium of claim 16, wherein providing the location of a feature on the map comprises indicating the location of the feature on the map with a marker.
